(19) United States
(12) Patent Application Publication
(10) Pub. No.: US 2006/0128589 A1
(43) Pub. Date: Jun. 15, 2006

(54) Low VOC air intake system cleaner

(75) Inventor: Kenneth E. Shriner, Wichita, KS (US)

Correspondence Address: SHOOK, HARDY & BACON LLP;INTELLECTUAL PROPERTY DEPARTMENT, 2555 GRAND BLVD, KANSAS CITY,, MO, 64108-2613, US

(73) Assignee: BG Products, Inc., Wichita, KS (US)

(21) Appl. No.: 11/298,254

(22) Filed: Dec. 9, 2005

Related U.S. Application Data
(60) Provisional application No. 60/634,721, filed on Dec. 9, 2004.

(51) Int. Cl. C11D 17/00

(52) U.S. Cl. 510/407; 510/499

(57) ABSTRACT

Disclosed is a method and a Volatile Organic Compound (VOC) cleaning composition for cleaning the air intake system of a engine, the cleaning composition comprising, a pyrrolidinone, an alcohol, and a VOC solvent. The Volatile Organic Compound (VOC) cleaning composition is used to clean contaminants from the plenum of an internal combustion engine by spraying or otherwise introducing the composition into the plenum.

### CROSS-REFERENCE TO RELATED APPLICATIONS

This application claims the benefit of U.S. Provisional Application No. 60/634,721, filed Dec. 9, 2004.

### STATEMENT REGARDING FEDERALLY SPONSORED RESEARCH OR DEVELOPMENT

Not applicable.

### BACKGROUND OF THE INVENTION

The invention relates to the maintenance of automobile internal combustion engines, and more particularly, to a method of cleaning a fuel injected engine plenum through the idle air control (IAC) port using a particular cleaner.

In order for automobile engines to function efficiently, it is important that sludge, varnish and other unwanted elements are not allowed to accumulate on the surfaces of the air intake assembly. Prior art systems for cleaning these impurities exist. For example, U.S. Pat. No. 6,655,392 issued to Erwin et al., which is commonly owned along with this application, discloses the use of a solvent which is introduced into the plenum through the IAC port.

Recently, numerous states, including the North East Coastal states, have adopted new Volatile Organic Compound (VOC) regulations. These regulations restrict the amount of smog producing chemicals that can be allowed to evaporate into the atmosphere. Particularly in areas having high population densities. Because of this, the prior art methods for cleaning fuel injected engine plenums have presented compliance problems. Thus, there is a present need in the art for an effective plenum cleaning method in which VOC's standards are met.

### DETAILED DESCRIPTION OF THE INVENTION

The present invention has overcome these prior-art compliance problems. This has been accomplished by developing a low VOC, organic-solvent-based air-intake-system cleaner which has proven to have surprising success in removing engine deposits. In one embodiment, this cleaner may be used with the method and apparatus as outlined in the '392 patent discussed above. The '392 system and method should not, however, be considered a limitation of the present invention. Other methods of delivery or uses are possible, even probable which would fall within the scope of the present invention.

The solvent includes a low VOC cleaning chemistry having a VOC content of less than 45 mass percent. This makes it subject to compliance in terms of the VOC standards set by, e.g., the Ozone Transport Commission's “Model Rule for Consumer Products” and other standards held by other government agencies.

This chemistry is capable of removing a very high percentage of air intake assembly deposits in a short time span and restore air flow, control systems, sensors, and emissions. This results in better drivability and pollution control.

This chemistry includes a combination of: (i) solvents in which VOC compliance is required, and (ii) VOC exempt solvents. The formulation meets specific viscosity and volatility requirements, and utilizes a synergistic interaction which occurs between a pyrrolidinone and an alcohol. Preferably a volatile alcohol. These agents have been shown to achieve optimum cleaning of engine air intake plenums.

In summary, at least one component of the engine-cleaning chemistry includes a synergistic combination of a pyrolidinone with a C1 to C12 alkyl, alkenyl, cyclo paraffinic, or aromatic constituent in the 1 position and a C1 to C8 alcohol. A preferred pyrrolidinone is 1-methyl-2-pyrrolidinone. The preferred other component is an alcohol, preferably methanol. These components will form a cleaning composition containing a specific ratio of VOC compliant and VOC exempt solvents with a viscosity between 0.4 to 2.0 cSt @ 40° C. More specifically, the viscosity will be between 0.5 and 1.0 cSt @ 40° C.

In other embodiments, the air intake system cleaning composition is prepared to acetone or methyl acetate as the VOC exempt component.

In some embodiments the cleaning composition may include a petroleum distillate with less than 1% aromatics, paraffinic, naphthenic, or a blend of paraffinic and naphthenic molecules and a vapor pressure of less than 0.1 mm Hg and a dry point of less than 350° C. as the VOC compliant component. More specifically, the VOC compliant solvent might comprise a petroleum distillate with less than 1% aromatics, a blend of paraffinic and naphthenic molecules and a dry point of less than 300° C.

In another embodiment, the air intake system cleaning composition may contain a volatile aromatic solvent. This volatile aromatic solvent might comprise toluene, xylenes, or an aromatic distillate with a distillation dry point by ASTM D86 of less than 225° C.

The invention is designed to be atomized and then introduced into the internals of an engine. As noted earlier, one way of accomplishing this is the method described in the '392 patent. BG Products, Inc. located in Wichita Kans. markets a product referred to as the BG AIS Cleaning Tool Kit, Part No. 9206 which embodies at least some of the disclosures in U.S. Pat. Nos. 6,772,772 and 6,478,036. The chemical cleaner may also be used in an aerosol form referenced as BG Air Intake System Cleaner, Part No. 406 which embodies disclosures from U.S. Pat. Nos. 6,772,772 and 6,478,036.

The air intake cleaning chemistry includes a combination of VOC exempt or VOC compliant organic solvents and takes advantage of a synergistic cleaning effect between a pyrrolidinone and an alcohol.

A VOC is defined as any compound of carbon, excluding carbon monoxide, carbon dioxide, carbonic acid, metallic carbides or carbonates, and ammonium carbonate, which participates in atmospheric photochemical reactions. In more practical terms, an organic solvent is considered a VOC under the following conditions: (i) the compound evaporates under the conditions of ARB Method 310 (EPA method 24), (ii) has a boiling point that is less than 216° C., (iii) has a vapor pressure that is greater than 0.1 mm Hg@20° C., or (iv) is a chemical compound with less than 13 carbon atoms. VOC compliant solvents would meet one of the four criteria. VOC exempt solvents do not meet any of the criteria but are considered non-VOC because they are proven not to be photo-chemically reactive and contributing to smog formation.

These requirements, however, have tended to interfere with past success in the field of cleaning engine contaminants. Such cleaning applications require a high degree of volatility and a low viscosity in order for the cleaning chemistry to successfully atomize and effectively clean the far reaching areas of the air intake plenum in relation to the idle air intake port. The chemistry also must not have such a slow evaporation rate as to allow the chemistry to collect, or puddle in low-lying areas of the plenum. This phenomenon has the potential to cause hydro locking if the puddled cleaning solvent enters the combustion chamber too rapidly.

Some conventional volatile, low viscosity solvents are exempt from the VOC criteria. But these compounds, including acetone and methyl acetate, exhibit inferior cleaning abilities. Especially in terms of eliminating the hardened types of deposits found in a dirty air intake plenum.

The exempt halogenated organic solvents are unsuitable since they will form acids during combustion with subsequent corrosion and damage to emission control systems.

A class of petroleum distillates having vapor pressures below the 0.1 mm Hg @ 20° C. limit and therefore VOC compliant, were found to be very effective at cleaning in this application in terms of filling the required mass % of the VOC compliant portion of the cleaner formulation. Examples of the VOC compliant petroleum distillates would include Sasol LPA®-170, Sasol LPA®-210, Sasol LPA®-47, EXXOL®D95, EXXOL®110, EXXOL®130, EXXOL ®D200, Exxon ISOPAR®M and Exxon ISOPAR®V. The preferred solvent is EXXOL®D95 solvent from Exxon Chemical Company, which is a low aromatic, and contains a mixture of paraffinic and naphthenic molecules. Other similar solvents having similar to EXXOL®D95 are on the market and may be used as well. The preferred combination of VOC compliant solvents would include a combination of low viscosity and high volatility, VOC exempt solvents such as acetone or methyl acetate and the EXXOL®D95 (or other) solvent. This combination reduced the viscosity and increased the volatility of the VOC compliant fraction giving better atomization and cleaning relative to the low vapor pressure petroleum distillate alone. The ideal viscosity would be 0.4 to 1.0 cST @ 40° C. by ASTM D445 with a viscosity of 2.0 cSt and above being considered too high for effective cleaning of the air intake plenum by atomization through the idle air intake port. The preferred VOC exempt solvent is acetone.

The deposit found in the air intake plenum of a port fuel injected engine contains a variety of chemical functional groups including, among others, alcohols, aldehydes, ketones, and carboxylic acids from the oxidation and nitration of hydrocarbons as well as paraffinic, naphthenic, and aromatic versions of the hydrocarbon themselves. To optimize the removal of these deposits, the chemical composition of the cleaner should be selected such that it matches as closely as possible the chemical composition of the deposit in terms of functional groups. If a paraffinic/naphthenic VOC compliant solvent is used such as the preferred EXXOL ®D95, an aromatic solvent may also be incorporated into the cleaning formula such as toluene, xylenes or an aromatic distillate with a dry point of less than 225° C., and in like fashion, if the VOC compliant petroleum fraction is an aromatic solvent, then a paraffinic/napthenic solvent may also need to be incorporated into the chemistry of the cleaner for optimum efficiency.

The VOC fraction, because of various environmental regulations must be reduced to a certain level, depending on the application as described in, for example, the Ozone Transport Commission's “Model Rule for Consumer Products” (OTC) regulations governing the North Atlantic States. For example, the OTC regulations call for Air Intake System Cleaners to contain a maximum of 45% VOC solvents starting Dec. 31, 2004. A primary attribute of this cleaning composition this that the VOC level is less than 45% by mass.

The pyrrolidinones are very effective at softening and removing hard, baked on carbon deposits. Especially at elevated temperatures. Examples of pyrrolidinones include 1-methyl-2-pyrrolidinone, 1-ethyl-2-pyrrolidinone, 1-Ethenyl-2-pyrrolidinone, 1-propyl-2-pyrrolidinone, etc. Still another example of a pyrrolidinones is a cyclohexyl pyrrolidinone The alkyl groups which can be attached to the pyrrolidinone molecule can be C-1 to C-12 including cyclohexyl and benzene rings. The preferred pyrrolidinone is 1-methyl-2-pyrrolidinone, which must be kept at a relatively low concentration since it is classified as a VOC solvent, but low concentrations initially did not show suitable cleaning until an unexpected synergism was found when 1-methyl-2-pyrrolidinone was used in combination with an alcohol.

The alcohol could include a C-1 to a C-12 alcohol, including but not limited to methanol, ethanol, n-propanol, etc. The carbon chain of the alcohol can be branched or unbranched and the hydroxyl group of the alcohol can be in the normal, iso, or tertiary position. The preferred alcohol used in combination with the preferred n-methyl pyrrolidinone was found to be methanol. This is because methanol has high polarity, volatility and acidity relative to other alcohols. The less volatile alcohols, with initial boiling points greater than 216° C. by ASTM D86, were found to less effective for air intake cleaning applications. This is because of the relatively high viscosity and propensity to resist evaporation. The cleaning efficiency in the described application was found to be dramatically improved when these two solvents, 1-methyl-2-pyrrolidinone and methanol, were used in combination versus individually allowing lower concentrations to meet the VOC constraints as dictated by regulation.

In terms of the overall formulation, the following embodiment has been shown to meet the above stated cleaning performance and VOC objectives. One embodiment for the formulation is set forth in the Table I below in mass percentages.

TABLE I

| | |
|---|---|
| Acetone | 25% |
| Exxol D95 | 35% |
| methanol | 10% |
| xylenes | 15% |
| 1-methyl-2-pyrrolidinone | 20% |

As can be seen from the table, the formula has a 45% VOC which is within the rules. Per the rules, the combined mass for the VOC subject components—methanol, xylenes, and 1-methyl-2-pyrrolidinone—does not exceed the 45% limit. The above formulation has also proven to satisfy its cleaning requirements.

Though Table I shows one embodiment of the present invention, it should be understood that the above percentages could vary, even be dramatically different, and still fall within the scope of the present invention. See TABLE II below. Further, they are intended as approximations only, and not to be considered precision bound. Also, it should be understood that not all the components listed are necessarily included in the scope of the present invention, nor is the invention excluding the possibility that numerous other ingredients could be substituted for each as suggested in more detail above. This is only intended as one of many embodiments which would be included in the scope of the present invention.

In addition to the use of this cleaning composition with application tools designed and marketed by BG Products Incorporated, other introduction methods may also be used. An aerosol version of the cleaning composition would also be valuable if CO2 is the propellant. The composition is essentially free of water with no intentional addition of water. Since carbon dioxide and water form carbonic acid, CO2 is not generally used in water based formulations because the acid will corrode the metal container. Carbon dioxide would be an ideal propellant for this composition, especially considering it would be considered VOC exempt. Other applications, which should not be excluded, are introduction of the cleaning composition through other areas besides the idle air control port. Changing technology and changing configuration of the air intake plenum should not exclude applications or introduction of the described cleaning composition from another physical location or with different application tools designed to apply the cleaning composition through the idle air intake port region or another physical location.

The invention was tested by three methods for relative cleaning efficiency. The first method involved observing and photographing the inside of air intake plenums before and after chemical treatment with an Olympus IV6C6-13 boroscope with an Olympus ILC-CI light source. The numbered formulas of TABLE II were each tested during the first method.

TABLE II

| | Formula # | | | | | | |
|---|---|---|---|---|---|---|---|
| | 1 | 2 | 3 | 4 | 5 | 6 | 7 |
| Acetone | 25 | 35 | 35 | 50 | 54.5 | 25 | 55 |
| Methyl Acetate | 10 | 20 | 5 | | | | |
| 1-methyl-2- | 20 | 20 | 30 | 15 | 10 | 20 | 10 |
| pyrrolidinone | | | | | | | |
| Xylenes | 20 | 20 | | | | | |
| Toluene | | | | 15 | 25 | | 25 |
| Methanol | | | | | | | |
| Isopropanol | 3 | 5 | 10 | 10 | | | |
| Tergitol ® 15-S-7 | 2 | | | | 0.5 | | |
| Morpholine | | | | 5 | | | |
| Ethylene Glycol | | | | 5 | | 20 | |
| Phenol Ether | | | | | | | |
| Tetrahydrofuran | | | | | 10 | | |
| Cyclohexanone | | | | | | 5 | |
| Dipentene | | | | | | | 10 |
| Diacetone Alcohol | | | | | | | |
| Cyclohexyl | | | | | | | |
| pyrrolidinone | | | | | | | |
| Exxol Aromatic D200 | | | | | | | |
| Exxol D95 Solvent | | | | | | | |
| Water | 20 | | 20 | | | 30 | |
| Total | 100 | 100 | 100 | 100 | 100 | 100 | 100 |

| | Formula # | | | | | |
|---|---|---|---|---|---|---|
| | 8 | 9 | 10 | 11 | 12 | 13 |
| Acetone | 55 | 35 | 35 | 25 | 25 | 25 |
| Methyl Acetate | | | | | | |
| 1-methyl-2-pyrrolidinone | | 5 | | | 20 | 20 |
| Xylenes | 10 | | 17 | | 15 | 15 |
| Toluene | 20 | 32 | 20 | 37 | | |
| Methanol | 3 | 3 | 8 | 8 | 10 | |
| Isopropanol | | | | | | 10 |
| Tergitol ® 15-S-7 | | | | | | |
| Morpholine | | | | | | |
| Ethylene Glycol Phenol Ether | | | | | | |
| Tetrahydrofuran | | | | | | |
| Cyclohexanone | | | | | | |
| Dipentene | 5 | | | | | |
| Diacetone Alcohol | 7 | 5 | | | | |
| Cyclohexyl pyrrolidinone | | | 20 | 20 | | |
| Exxol ® Aromatic D200 | | 20 | | 10 | | |
| Exxol ® D95 Solvent | | | | | 30 | 30 |
| Water | | | | | | |
| Total | 100 | 100 | 100 | 100 | 100 | 100 |

All values shown in weight percent.

In most instances the results of the testing of the first method generally yielded near 100% cleanup with formulas 9 through 13. The most favorable aspects of the visual observation were the improved cleaning of the difficult to remove deposits close to the intake valves and the uniform cleaning of the plenum. The back sides of the throttle plates were also completely cleaned in the tests performed.

For the second testing method, a Ferret 14 GasLink LT Emissions Analyzer was used to measure tail pipe emissions before and after treatment with the Low VOC Air Intake System Cleaner invention. The Low VOC Air Intake System Cleaner formula used for the second tested method is located in column 13 of TABLE II. This method was used to determine the effectiveness of the cleaning process at improving the efficiency of the combustion process. Older model, high mileage vehicles were chosen for the analysis because the emission control systems would not be working at optimum efficiency and discrimination based on tail pipe emissions would better reflect the effectiveness of the cleaning process. The high mileage vehicles would also most likely have plenum deposits high enough to significantly affect engine performance. The following tables illustrate the lowering of hydrocarbons and carbon monoxide from the high mileage vehicles:

TABLE III

| | | Hydrocarbons | Hydrocarbons | Hydrocarbons | Hydrocarbons |
|---|---|---|---|---|---|
| | | Before Service | After Service at | Before Service | After Service at |
| Vehicle | Mileage | at Idle | Idle | at 60 MPH | 60 MPH |
| 1994 Chevy | 129,686 | 390 ppm | 232 ppm | 21 ppm | 9 ppm |
| Lumina 3.1 L | | | | | |
| 1996 Chevrolet | 186.945 | 214 ppm | 4 ppm | 19 ppm | 21 ppm |
| Cavalier 2.4 L | | | | | |
| 1994 Mercury | 136,860 | 335 ppm | 69 ppm | 98 ppm | 0 ppm |
| Topaz, 3.0 L | | | | | |
| 1992 Pontiac | 103411 | 264 ppm | 180 ppm | 66 ppm | 123 ppm |
| Grand AM 2.3 L | | | | | |
| 1992 Dodge | 145,010 | 378 ppm | 110 ppm | 51 ppm | 39 ppm |
| Grand Caravan | | | | | |
| 3.3 L | | | | | |
| 1992 Ford F-150 | 199,482 | 50 ppm | 7 ppm | 57 ppm | 22 ppm |
| 5.0 L | | | | | |
| 1988 Ford F-150 | 245,079 | 137 ppm | Erratic reading | 84 ppm | 55 ppm |
| 4.9 L | | | | | |

TABLE IV

| | | Carbon | Carbon | Carbon | Carbon |
|---|---|---|---|---|---|
| | | Monoxide | Monoxide After | Monoxide | Monoxide |
| Vehicle | Mileage | Before at Idle | at Idle | Before at 60 MPH | After at 60 MPH |
| 1994 Chevy | 129,686 | 0.33% | 0.12% | 0.04% | 0.02% |
| Lumina 3.1 L | | | | | |
| 1996 Chevrolet | 186.945 | 0.32% | 0.00% | 0.03% | 0.01% |
| Cavalier 2.4 L | | | | | |
| 1994 Mercury | 136,860 | 0.74% | 0.11% | 0.16% | 0.02% |
| Topaz, 3.0 L | | | | | |
| 1992 Pontiac | 103411 | 1.84% | 0.12% | 0.14% | 0.03% |
| Grand AM 2.3 L | | | | | |
| 1992 Dodge | 145,010 | 0.72% | 0.08% | 0.21% | 0.14% |
| Grand Caravan | | | | | |
| 3.3 L | | | | | |
| 1992 Ford F-150 | 199,482 | 0.04% | 0.01% | 0.14% | 0.04% |
| 5.0 L | | | | | |
| 1988 Ford F-150 | 245,079 | 0.08% | 0.01% | 0.04% | 0.01% |
| 4.9 L | | | | | |

The Ferret 14 Analyzer was calibrated before and during testing with 1200 ppm hydrocarbon, 4% carbon monoxide, 12% carbon dioxide, and 1000 ppm nitrogen oxide standard gas solution from Scott Specialty Gases.

A third method for measuring the cleaning efficiency involved the recording of the Idle Air Control Percent Setting using a Snap-on Graphing Scanner model series MTG2500 before and after the cleaning process with the BG 9202 tool and the low VOC cleaning formulation discussed above in column 13 of TABLE II. The following table discusses the lowering of air control percentage before and after treatment:

TABLE V

| | | Idle Air Control | Idle Air Control |
|---|---|---|---|
| | | Percentage | Percentage |
| Vehicle | Mileage | Before Service | After Service |
| 1994 Chevy | 129,686 | 34% | 7% |
| Lumina 3.1 L | | | |
| 1996 Chevrolet | 186.945 | 29% | 9% |
| Cavalier 2.4 L | | | |
| 1994 Mercury | 136,860 | 32.8% | 16.4% |
| Topaz, 3.0 L | | | |
| 1992 Pontiac | 103411 | 25% | 16% |
| Grand AM 2.3 L | | | |
| 1992 Dodge | 145,010 | 17% | 5% |
| Grand Caravan | | | |
| 3.3 L | | | |
| 1992 Ford F-150 | 199,482 | 59.2% | 28.0% |
| 5.0 L | | | |
| 1988 Ford F-150 | 245,079 | * | * |
| 4.9 L | | | |

* Unable to get reading from scan tool.

The idle air control percentage values can range from zero to 100 percent and represent the amount of air flow the automobiles computer determines is necessary to maintain a proper idle speed. The lower value would represent both less restriction of air flow caused by deposits and more efficient utilization of the air entering the combustion chamber.

As a follow-up to the emission and idle air control testing with the new low VOC air intake cleaning chemistry, the 1994 Mercury Topaz was brought back into the test facility seven days and 200 miles after the cleaning service and the emissions test repeated. This step was performed to determine if the lower emissions were maintained beyond the day of the cleaning procedure. The testing gave 88 ppm hydrocarbons versus 69 ppm 7 days prior, 0.07% carbon monoxide versus 0.11% and the idle air control percentage was 16.4, which was identical to the previous reading. These values would indicate the lowered emission values are indeed maintained after the cleaning process with the invention.

What is claimed is:

1. A low Volatile Organic Compound (VOC) cleaning composition for cleaning the air intake system of a engine, the cleaning composition comprising:
at least one pyrrolidinone;
at least one alcohol; and
a third component.

2. The cleaning composition of claim 1, wherein said third component includes at least one VOC compliant solvent.

3. The cleaning composition of claim 1, wherein said third component includes at least one VOC compliant solvent and at least one VOC exempt solvent.

4. The cleaning composition of claim 3, wherein said pyrrolidinone is selected from a group consisting of 1-methyl-2-pyrrolidinone, 1-ethyl-2-pyrrolidinone, 1-Ethenyl-2-pyrrolidinone, 1-propyl-2-pyrrolidinone, and cyclohexyl pyrrolidinone.

5. The cleaning composition of claim 4, wherein said alcohol is selected from a group consisting of C-1 to C-12 alcohols.

6. The cleaning composition of claim 5, wherein said third component includes said at least one VOC compliant solvent and said at least one VOC exempt solvent having greater than 55 mass % with a viscosity between 0.4 to 2.0 cSt @ 40° C.

7. The cleaning composition of claim 6, wherein said third component includes at least one VOC compliant solvent and at least one VOC exempt solvent having greater than 55 mass % with a viscosity between 0.5 to 1.0 cSt @ 40° C.

8. The cleaning composition of claim 7, wherein said at least one VOC exempt solvent is selected from a group consisting of acetone and methyl acetate.

9. The cleaning composition of claim 7, wherein said at least one VOC compliant solvent is selected from a group consisting of Sasol LPA®-170, Sasol LPA®-210, Sasol LPA®-47, EXXOL®D95, EXXOL®110, EXXOL®130, EXXOL®D200, Exxon ISOPAR®M, Exxon ISOPAR®V, or similar solvent, which is a petroleum distillate with low aromatics and a blend of paraffinic and naphthenic molecules.

10. The cleaning composition of claim 9, wherein said petroleum distillate with low aromatics, paraffinic, and naphthenic molecules has a vapor pressure of less than 0.1 mm Hg and a dry point of less than 350° C.

11. A method for cleaning contaminants from an internal component of a combustion engine, comprising:
including at least one pyrrolidinone, at least one alcohol, and a third component in a cleaning agent; and
introducing said cleaning agent into said engine to remove said contaminants.

12. The method of claim 11, wherein said third component includes at least one VOC compliant solvent.

13. The method of claim 11, wherein said third component includes at least one VOC compliant solvent and at least one VOC exempt solvent

14. The method of claim 13, wherein said at least one pyrrolidinone is selected from a group consisting of 1-methyl-2-pyrrolidinone, 1-ethyl-2-pyrrolidinone, 1-Ethenyl-2-pyrrolidinone, 1-propyl-2-pyrrolidinone, and cyclohexyl pyrrolidinone.

15. The method of claim 14, wherein said at least one alcohol is selected from a group consisting of C-1 to C-12 alcohols.

16. The method of claim 15, wherein said at least one VOC compliant solvent includes said at least one VOC compliant solvent and said at least one VOC exempt solvents of greater 55 mass % with a viscosity between 0.4 to 2.0 cSt @ 40° C.

17. The cleaning composition of claim 16, wherein said third component includes at least one VOC compliant solvent and at least one VOC exempt solvent having greater than 55 mass % with a viscosity between 0.5 to 1.0 cSt @ 40° C.

18. The method of claim 17, wherein said at least one VOC exempt solvent is selected from a group consisting of acetone and methyl acetate.

19. The method of claim 18, wherein said at least one VOC compliant solvent is selected from a group consisting of Sasol LPA®-170, Sasol LPA®-210, Sasol LPA®-47, EXXOL®D95, EXXOL®110, EXXOL®130, EXXOL®D200, Exxon ISOPAR®M, Exxon ISOPAR®V, or similar solvent, which is a petroleum distillate with low aromatics composed of paraffinic and naphthenic molecules.

20. A low Volatile Organic Compound (VOC) cleaning composition for cleaning the air intake system of a engine, the cleaning composition comprising:
a first component comprising at least one pyrrolidinone;
a second component comprising at least one alcohol; and
a third component comprising at least one VOC compliant solvent and at least one VOC exempt solvent.
